(19) United States
(12) Patent Application Publication
(10) Pub. No.: US 2008/0155955 A1
(43) Pub. Date: Jul. 3, 2008

(54) Head Assembly For A Rotary Line Trimmer

(76) Inventor: Francis John Walker, Tauranga (NZ)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/573,641

(22) PCT Filed: Aug. 12, 2004
(86) PCT No.: PCT/NZ2004/000181

§ 371 Date: Sep. 17, 2007

(51) Int. Cl. A01D 34/416

(52) U.S. Cl. 56/12.7; 30/337

(57) ABSTRACT

A head assembly (1) for a rotary line trimmer includes a hub (2) and cap (3) screw threaded together. The hub (2) has an opening (7) for receiving a fastener for fixing the hub (2) to a rotating shaft of the line trimmer. The cap (3) has at least one aperture (6, 6′) therein for receiving a continuous length of cutting line (5, 5′). Opposing faces on the hub (2) and cap (3) cooperate to clamp each length of cutting line (5, 5′) therebetween when the cap (3) is screwed onto the hub (2).

### TECHNICAL FIELD

The present invention relates to rotary line trimmers, and more particularly to a head assembly which holds a length of cutting line.

### BACKGROUND ART

Rotary line trimmers are well known and incorporate a line as a cutter attached to a rotating head assembly. A portion of the line extends beyond a hub of the trimmer. When the hub is rapidly rotated by a motor, the line becomes an effective cutting device for grasses, weeds and other foliage. The line can be made of any number of durable materials such as flexible nylon.

The line is worn away by use, and so must be replaced. There are two basic approaches to replacing cutting line. In one approach, a supply of line is wound on a spool placed within a hub and is played out either manually or automatically when the cutting portion of the line becomes too short. Using a rotating spool has the advantage of keeping a relatively large supply of line on hand for immediate use. Consequently, it is-the preferred-approach for rotary line trimmers suitable for trimming tougher vegetation or a large area of vegetation. However, spools tend to be relatively complicated mechanisms that are expensive to manufacture and/or difficult to use. Also, each part adds weight and increases the likelihood of failure.

A second type places a single length of line within a head element. The line is mechanically held in place by a fastener. The head is attached to a shaft connected to the trimmer's motor. When the line is worn, the fastener can be released and the line replaced. This design is lighter and less expensive to construct. In one device of this type the fastener is a plastic clip which can easily deform or break. Also, dirt and grass can keep the clip from closing.

A variation of the second type includes a cap with radially extending apertures therein for receiving the cutting line. A bolt or screw is used to clamp the lines to the cap. A hub is fastened to the rotating output shaft of the trimmer, the cap and the hub having male and female threaded portions respectively for fixing them together. While the enclosed cap prevents dirt and grass from affecting the proper clamping of the lines, this design has some disadvantages. In particular, providing the screw or bolt and forming the corresponding threaded aperture in the cap adds to the expense of manufacture. Line replacement is more troublesome as a tool is required for loosening the screw or bolt.

Therefore, a need exists for an improved head assembly for holding a line for a rotary line trimmer. The head assembly should be simple and inexpensive to construct. The head should securely hold one or more lengths of line. The method of securing the line should be easily manipulated to remove the line.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention there is provided a head assembly for a rotary line trimmer including:
a hub having an opening for receiving a fastener for fixing the hub to a rotating shaft of the line trimmer for rotation about an axis thereof, the hub having a first screw thread and
a cap with a second screw thread for engaging the first screw thread on the hub, at least one aperture through the cap for receiving a length of cutting line therethrough, wherein
opposing faces on the hub and cap cooperate to clamp each length of line therebetween when the cap is screwed onto the hub.

Preferably pairs of diametrically opposed apertures are formed in a cylindrical portion of the cap. Such configuration permits a continuous length of line to be inserted through the cap to extend substantially equidistantly from either side. It will, however, be appreciated that a length of line may extend solely through a single aperture, and/or that a continuous piece of flexible line may be brought to pass through two non opposed apertures.

The opposing faces of the hub and cap are preferably radially extending, most preferably annular. The cap preferably has a closed domed end.

The first and second screw threads are preferably external and internal screw threads respectively, although the converse arrangement is also possible.

This invention provides a head assembly for a rotary line trimmer which simplifies line replacement in operational use, may be economically constructed and has an overall simple design which minimizes manufacturing costs and maximizes performance.

### BRIEF DESCRIPTION OF THE DRAWINGS

Further aspects of the present invention will become apparent from the following description which is given by way of example only and with reference to the accompanying drawings in which:

FIG. 1 is a side elevation of the head assembly of the present invention;

FIG. 2 is cross section XX from FIG. 1;

FIG. 3 is detail Y from FIG. 2;

FIG. 4 is a pictorial view of the hub of the head assembly of FIG. 1;

FIG. 5 is a pictorial view of the cap of the head assembly of FIG. 1, and

FIG. 6 is an exploded view of the head assembly of FIG. 1.

### BEST MODES FOR CARRYING OUT THE INVENTION

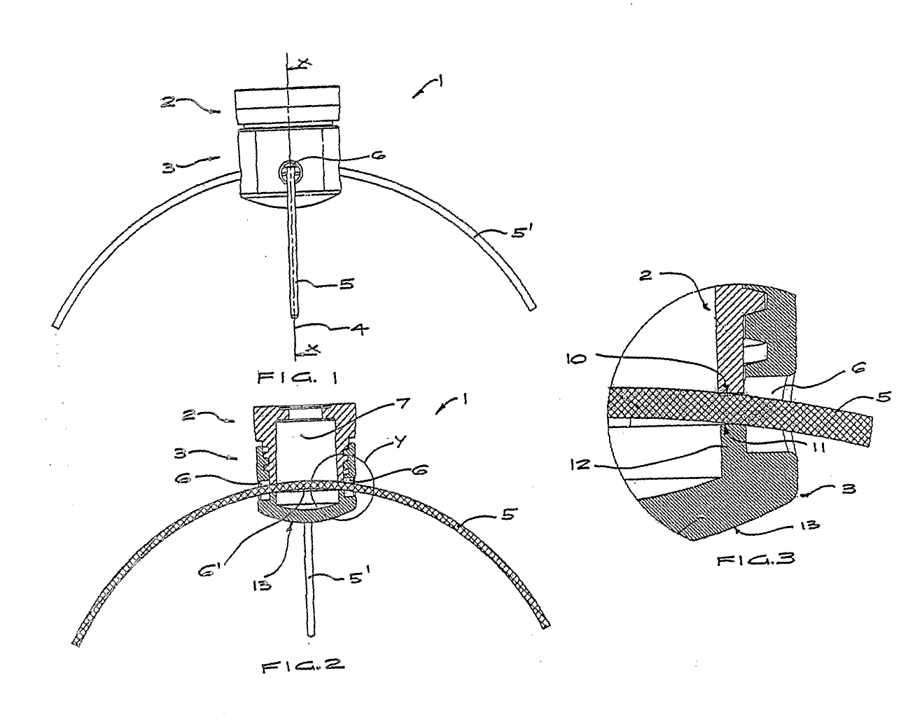

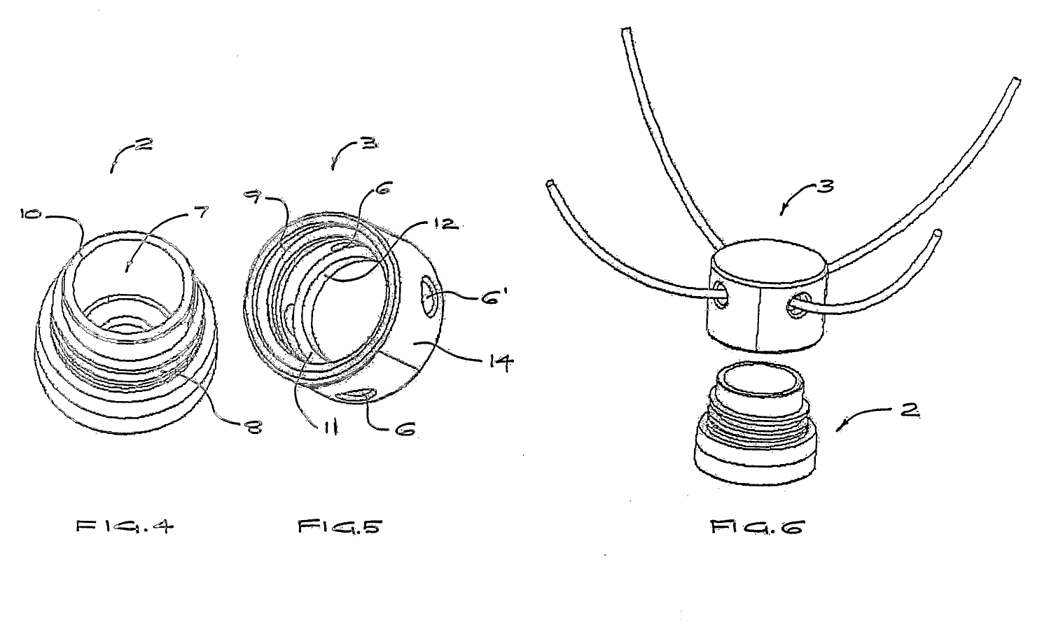

Referring to FIGS. 1-5, the head assembly 1 includes a hub 2 fixed to a cap 3, both the hub 2 and cap 3 being symmetrical about a central axis 4. Two lengths of cutting line 5, 5′ are respectively received in two pairs of diametrically extending apertures 6, 6′ in the hub 3. In use the head assembly 1 is fixed to the rotating output shaft (not shown) of a line trimmer for rotating the head assembly 1 about axis 4.

The hub 3 has a central axially-extending opening 7 for receiving a fastener such as a nut (not shown) and providing access for a tool for tightening the nut for fixing the hub 3 to the shaft of the line trimmer. An external screw thread 8 is provided on the hub 2 for engaging a corresponding internal thread 9 for fixing the hub 2 and cap 3 together. The annular face 10 on the end of the hub 2 cooperates with the annular face 11 formed on the shoulder 12 inside the cap 3 for clamping the lines 5, 5′ therebetween to fix them to the head assembly 1.

The cap 3 has a closed domed end such that when the cap 3 and hub 2 are assembled dirt and grass etc is largely prevented from getting inside the head assembly 1. The apertures 6, 6′ are formed in a cylindrical portion 14 of the cap 3.

The cap 3 and hub 2 may be formed from metal or rigid plastic material. Depending upon the direction of rotation of the shaft of the line trimmer, the screw threads 8, 9 may be left or right-handed.

In use, once the hub 2 has been fixed to the trimmer, the cutting lines 5, 5′ may be replaced by manually grasping and unscrewing the cap 3 to release the clamping engagement with the lines (see FIG. 6). Replacement lines 5, 5′ can then be freely inserted into the apertures 6, 6′ before replacing and tightening the cap 3 onto the hub 2.

Aspects of the present invention have been described by way of example only and it should be appreciated that modifications and additions may be made thereto without departing from the scope thereof as defined in the appended claims.

1. A had assembly for a rotary line trimmer including:
a hub having an opening for receiving a fastener for fixing the hub to a rotating shaft of the line trimmer for rotation about an axis thereof, the hub having a first screw head and
a cap with a second screw thread for engaging the first screw thread on the hub, at least one aperture through the cap for receiving a length of cutting line therethrough, wherein
opposing faces on the hub and cap cooperate to clamp each length of line therebetween when the cap is screwed onto the hub.

2. The head assembly of claim 1 wherein at least one pair of diametrically opposed apertures are formed in a cylindrical portion of the cap.

3. The head assembly of claim 1 wherein the opposing faces of the hub and cap are radially extending.

4. The head assembly of claim 1 wherein the cap has closed doomed end.

5. The head assembly of claim 1 wherein the first and second screw threads are external and internal screw threads respectively.

6. The head assembly of claim 1 further including at least one cutting line fixed in each aperture in the cap.

7. (canceled)
